(19) United States
(12) Patent Application Publication
(10) Pub. No.: US 2014/0351902 A1
(43) Pub. Date: Nov. 27, 2014

(54) APPARATUS FOR VERIFYING WEB SITE AND METHOD THEREFOR

(71) Applicant: Electronics and Telecommunications Research Institute, Daejeon (KR)

(72) Inventors: Seung Hyun KIM, Daejeon (KR); Seung Hun JIN, Daejeon (KR); Jin Man CHO, Daejeon (KR); Young Seob CHO, Daejeon (KR); Sang Rae CHO, Daejeon (KR); Dae Seon CHOI, Daejeon (KR); Jong Hyouk NOH, Daejeon (KR); Soo Hyung KIM, Daejeon (KR); Seok Hyun KIM, Daejeon (KR); Hyun Sook CHO, Daejeon (KR)

(73) Assignee: Electronics and Telecommunications Research Institute, Daejeon (KR)

(21) Appl. No.: 14/285,253

(22) Filed: May 22, 2014

(30) Foreign Application Priority Data
May 24, 2013 (KR) 10-2013-0059102

(51) Int. Cl. H04L 29/06

(52) U.S. Cl. CPC H04L 63/08
USPC 726/5

(57) ABSTRACT

Disclosed are an apparatus and a method for verifying a web site by using a mobile terminal. A method, performed in a server verifying a web site, comprises receiving a message requesting verification on truth or falsehood of a web site which an access terminal accesses from the access terminal; processing the web site based on an Uniform Resource Location (URL) of the web site according to the message; generating verification information for verifying truth of falsehood of the web site based on the URL of the web site, and transmitting the verification information to a mobile terminal; and receiving verification result information on the web site which is generated in the mobile terminal based on an image of the web site and the verification information, and transmitting the verification result information to the access terminal.

### CLAIM FOR PRIORITY

This application claims priorities to Korean Patent Application No. 10-2013-0059102 filed on May 24, 2013 in the Korean Intellectual Property Office (KIPO), the entire contents of which are hereby incorporated by references.

### BACKGROUND

1. Technical Field

Example embodiments of the present invention relate to verification of web site, and more specifically to an apparatus and a method for verifying a web site by using a mobile terminal.

2. Related Art

A terminology ‘Phishing’ is a compound word of ‘Private data’ and ‘Fishing’. It means a cheating of disguising electronic mails or messages as those from a trustable person or company, and obtaining confidential information such as a password of a user, credit card number information, etc. fraudulently.

In case of electronic financial transaction, two-factor authentication using a security card, an one-time password (OTP) device, etc. has been generalized, and so it has been recognized as a safe zone from harms caused by phishing as compared with other domains.

However, fraud crimes, using a phishing site which tries issuance of certificate or illegal deposit transfers via a credit card loan service by using credit card information, private information, etc. obtained illegally, are increasing recently.

Especially, although a conventional phishing site could be easily recognized by a user as an abnormal web site since it has a static structure, a currently-used active phishing site adopts a structure in which a normal page is simply falsified and forwarded to a user so that a user cannot recognize whether the target web page is normal or falsified easily.

Also, since the active phishing site converts the normal web page into the falsified web page by removing security components of the normal web page appropriately and transfers the falsified web page to the user, security techniques used for protecting conventional phishing sites can be deactivated.

Although some techniques can cope with the active phishing site, there are inconveniences of demanding installation of additional hardware and software. Also, they can be used only in a specific device so that there may be a problem of mobility.

Meanwhile, although authentication techniques such as one-time password (OTP) method or Short Message Service (SMS) authentication method were evaluated as safe techniques due to effectiveness during only restricted time, it is very difficult to deactivate active phishing sites efficiently even by using the above techniques since active phishing sites can achieve illegal object in the restricted time.

### SUMMARY

Accordingly, example embodiments of the present invention are provided to substantially obviate one or more problems due to limitations and disadvantages of the related art.

Example embodiments of the present invention provide a web server verifying a web site which an access terminal accesses by interworking with a mobile terminal.

Example embodiments of the present invention also provide a method of verifying a web site which an access terminal accesses by using a web server and a mobile terminal.

In some example embodiments, a web server may comprise a link information processing part processing a web site which an access terminal accesses based on a Uniform Resource Location (URL) of the web site; a verification information generating part generating verification information for determining truth or falsehood of the web site based on the URL of the web site and transmitting the generated verification information to a mobile terminal; and a result information transmitting part receiving verification result information on the web site generated in the mobile terminal based on an image of the web site and the verification information, and transmitting the verification result information to the access terminal.

Here, the link information processing part may change the URL of the web site into a form of Hypertext Transfer Protocol over Secure socket layer (HTTPS).

Here, the link information processing part may add identification information of a user of the access terminal to the web site which the access terminal accesses based on the URL of the web site.

Here, the verification information may include at least one of URL information, session ID information, HTTPS channel configuration information, and information on a web browser of the access terminal.

Here, the verification information generating part may transmit the verification information to the mobile terminal in order for the mobile terminal to obtain an image of the web site processed by the link information generating part and compare the image and the verification information.

In other example embodiments, a mobile terminal may comprise a verification information receiving part receiving, from a web server, verification information for judging truth of falsehood of a web site which an access terminal accesses based on a Uniform Resource Location (URL) of the web site; an image processing part obtaining an image of the web site and processing the image; and a verification result information generating part generating verification result information on the web site based on the image and the verification information, and transmitting the verification result information to the web server.

Here, the verification information may include at least one of URL information, session ID information, HTTPS channel configuration information, and information on a web browser of the access terminal.

Here, the image processing part may comprises a camera part obtaining the image of the web site; and an image analyzing part extracting web site information including URL information or HTTPS channel configuration information by analyzing the image of the web site.

Here, the verification result information part may generate the verification result information by comparing the web site information extracted from the image of the web site with the verification information.

In still other example embodiments, a method, performed in a server verifying a web site, may comprise receiving a message requesting verification on truth or falsehood of a web site which an access terminal accesses from the access terminal; processing the web site based on a Uniform Resource Location (URL) of the web site according to the message; generating verification information for verifying truth of falsehood of the web site based on the URL of the web site, and transmitting the verification information to a mobile terminal; and receiving verification result information on the web site which is generated in the mobile terminal based on an image of the web site and the verification information, and transmitting the verification result information to the access terminal.

Here, the URL of the web site may be changed into a form of Hypertext Transfer Protocol over Secure socket layer (HTTPS) in the processing the web site.

Here, identification information of a user of the access terminal may be added to the web site which the access terminal accesses based on the URL of the web site in the processing the web site.

Here, the verification information may include at least one of URL information, session ID information, HTTPS channel configuration information, and information on a web browser of the access terminal.

Here, in the generating verification information and transmitting the verification information, the verification information may be transmitted to the mobile terminal in order for the mobile terminal to obtain an image of the web site and compare the image and the verification information.

Here, in the receiving verification result information and transmitting the receiving verification result information, web site information including URL information or HTTPS channel configuration information may be extracted by the mobile terminal based on analysis on the image of the web site, the verification result information may be generated by comparing the web site information and the verification information and transmitted to the access terminal.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram explaining a method of verifying a web site according to an example embodiment of the present invention;

FIG. 2 is a flow chart explaining a method for verifying a web site according to an example embodiment of the present invention;

FIG. 3 is a block diagram explaining a web site verification apparatus according to an example embodiment of the present invention; and

FIG. 4 is a flow chart explaining a method for verifying a web site performed in a web server according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

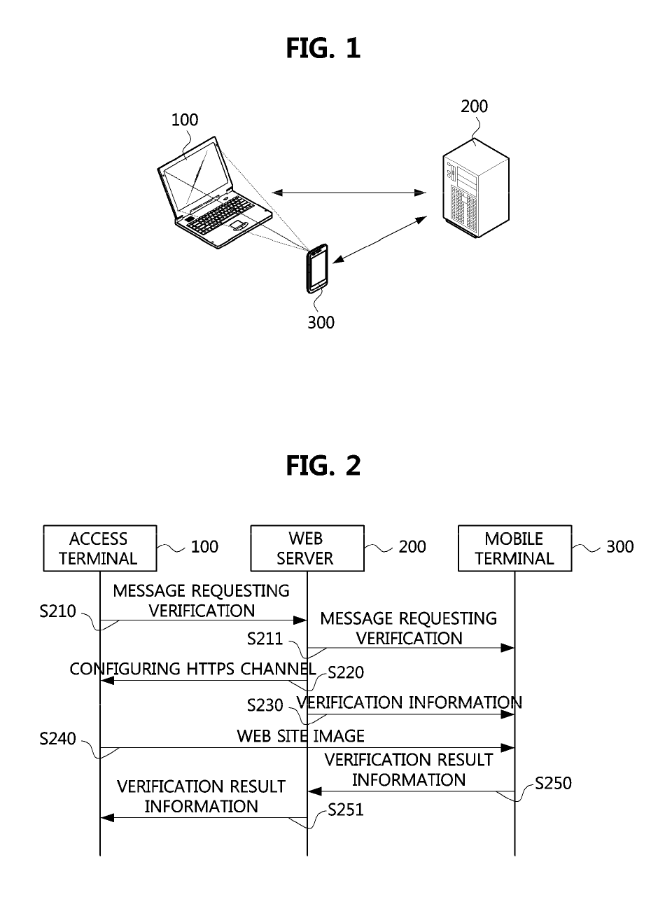

FIG. 1 is a conceptual diagram explaining a method of verifying a web site according to an example embodiment of the present invention.

Referring to FIG. 1, the method according to an example embodiment of the present invention may verify whether a web site which an access terminal 100 accesses is a normal site or a phishing site by using a mobile terminal 300 and a web server 200.

The access terminal 100 may mean a terminal which can access a web site such as a desktop PC, a notebook PC, a tablet, a smart phone, etc. Here, the access terminal 100 may comprise at least one of various web browsers. For example, the access terminal 100 may comprise at least one of various web browsers such as an Internet Explorer, a Firefox, a Chrome, an Opera, etc. Accordingly, in the present invention, the access terminal 100 may be understood as having an equivalent meaning to a web browser. However, the access terminal 100 is not limited to a web browser.

The web server 200 may mean a server providing a web site to the access terminal 100. For example, the web server 200 may provide the web site to the access terminal 100 by using Hyper Text Transfer Protocol (HTTP). That is, the web server 200 may provide, to the access terminal 100, a web site corresponding to a Uniform Resource Location (URL) inputted to the access terminal 100.

The mobile terminal 300 may mean a user terminal which can communicate with the web server 200 and has mobility. For example, the mobile terminal 300 may mean a smart phone, a tablet PC, etc. Especially, the mobile terminal 300 according to an example embodiment of the present invention may have a camera to obtain an image of the web site which the access terminal 100 accesses.

In order to verify whether the web site which the access terminal 100 accesses is a normal site or not, the access terminal 100 may transmit a message requesting verification on truth or falsehood of the web site to the web server 200, and so the verification on the web site is started.

When the web server 200 receives the message requesting verification on truth or falsehood of the web site, the web server 200 may generate verification information for determining whether the web site is normal or falsified based on the URL of the web site, and transmit the verification information to the mobile terminal 300. Also, the web server 200 may process the web site which the access terminal 100 accesses based on the URL of the web site.

Here, the URL is the one which can enable the web server 200 to search and analyze some information, files, or resources existing in internet, and the URL may represent all resources in computer networks as well as an address of a web site.

The mobile terminal 300 may receive the verification information from the web server 200, and extract information on the web site by analyzing an image of the web site displayed in the access terminal 100. Also, the mobile terminal 300 may generate verification result information by comparing the information on the web site with the verification information, and transmit the verification result information to the web server 200. Here, the verification result information may mean information on result of the determination on whether the web site which the access terminal 100 accesses is normal or falsified.

Therefore, the web server 200 may transmit the verification result information received from the mobile terminal 300 to the access terminal 100, and so notify the user whether the web site which the access terminal 100 accesses is a normal site or not.

FIG. 2 is a flow chart explaining a method for verifying a web site according to an example embodiment of the present invention.

Referring to FIG. 2, a method for verifying a web site according to an example embodiment of the present invention will be explained in detail. In the method according to an example embodiment of the present invention, whether a web site which the access terminal 100 accesses is normal or falsified may be determined by using the web server 200 and the mobile terminal 300.

A user of the access terminal 100 may transmit, to the web server 200, a message requesting verification on truth or falsehood of the web site which the access terminal 100 accesses through the access terminal 100 (S210). That is, verification on the web site is started when the user transmits the message requesting verification to the web server 200.

Also, the web server 200 may notify the start of verification on the web site by transmitting the message received from the access terminal 100 to the mobile terminal 300 (S211). Here, the message requesting verification may include information on the target web site, information on a web browser of the access terminal 100, identification information of the user using the access terminal 100, etc.

The web server 200 may process the web site which the access terminal 100 accesses based on the URL of the web site. That is, the web server 200 may establish a Hypertext Transfer Protocol over Secure socket layer (HTTPS) channel for the web site which the access terminal 100 accesses (S220).

Here, HTTPS is a security version of HTTP which is a world-wide web (WWW) communication protocol, and it is being widely used for electronic commerce since it has stronger security by authentication and encryption of communications.

For example, a URL of the web site which the access terminal 100 accesses may be changed into a form of HTTPS. Also, the web server 200 may represent identification information of the user of the access terminal 100 by adding the identification information of the user to the web site based on the URL of the web site which the access terminal 100 accesses. Here, the identification information of the user of the access terminal 100 may mean information for user identification such as a session ID, etc.

Also, the web server 200 may generate verification information for determining whether the web site which the access terminal 100 accesses is normal or falsified based on the URL of the web site, and transmit the generated verification information to the mobile terminal 300 (S230).

The mobile terminal 300 may obtain an image of the web site which the access terminal 100 accesses (S240), and extract information on the web site by analyzing the image of the web site. Here, the information on the web site may include URL information of the web site which the access terminal 100 accesses and HTTPS channel configuration information, etc.

The mobile terminal 300 may generate verification result information on the web site which the access terminal 100 accesses based on the image of the web site which the access terminal 100 accesses and the verification information, and transmit the generated verification result information to the web server 200 (S250). Also, the verification result information is transmitted to the access terminal 100 via the web server 200 (S251), and it can be notified to the user of the access terminal 100 whether the web site which the access terminal 100 accesses is normal or falsified.

Specifically, the mobile terminal 300 may extract web site information including URL information of the web site or HTTPS channel configuration information by analyzing the image of the web site which the access terminal 100 accesses, and generate the verification result information by comparing the web site information with the verification information. Here, the image on the web site obtained by the mobile terminal 300 may be an image of the web site processed by the web server 200.

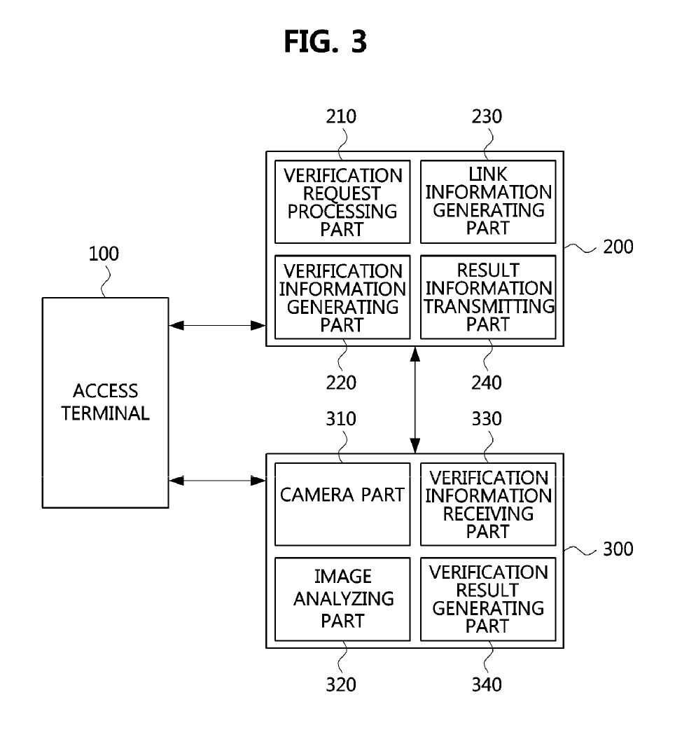

FIG. 3 is a block diagram explaining a web site verification apparatus according to an example embodiment of the present invention.

Referring to FIG. 3, the above-described method for verifying a web site according to an example embodiment of the present invention may be performed by information exchanges between the access terminal 100, the web server 200, and the mobile terminal 300.

First, the access terminal 100 may mean a user computer equipped with at least one of various web browsers.

Next, the web server 200 according to an example embodiment of the present invention may comprise a verification request processing part 210, a verification information generating part 220, a link information processing part 230, and a result information transmitting part 240.

The verification request processing part 210 may receive a message requesting verification for verifying a web site which the access terminal 100 accesses from the access terminal 100, and transmit the message requesting verification to the mobile terminal 300. That is, the user of the access terminal 100 may transmit, to the web server 200, the message requesting verification on truth or falsehood of the web site which the access terminal 100 accesses through the access terminal 100. Through the above transmission, verification on the web site may be started. Here, the message requesting verification may include information on the target web site, information on a web browser of the access terminal 100, identification information of the user using the access terminal 100, etc.

The link information processing part 230 may process the web site which the access terminal 100 accesses based on the URL of the web site. For example, the link information processing part 230 may change the URL of the web site which the access terminal 100 into a form of HTTPS.

Also, the link information processing part 230 may add the identification information of the user to the web site based on the URL of the web site which the access terminal 100 accesses. Here, the identification information of the user of the access terminal 100 may mean information for user identification such as a session ID, etc.

The verification information generating part 220 may generate verification information for determining whether the web site which the access terminal 100 accesses is normal or falsified based on the URL of the web site, and transmit the generated verification information to the mobile terminal 300. That is, the verification information includes URL information, session ID information, HTTPS channel configuration information, and information on a web browser of the access terminal 100. The verification information generating part 220 may generate the verification information, transmit the generated verification information to the mobile terminal, and make the mobile terminal 300 verify the web site by using the verification information. For example, the verification information generating part 220 may transmit the verification information to the mobile terminal 300 so that the mobile terminal 300 can compare the image of the web site with the verification information.

The result information transmitting part 240 may receive, from the mobile terminal 300, verification result information which are generated in the mobile terminal 300 based on the image of the web site which the access terminal 100 accesses and the verification information. Accordingly, the web server 200 may notify the user whether the web site which the access terminal 100 accesses is normal or falsified by transmitting the verification result information received from the mobile terminal 300 to the access terminal 100.

On the other hand, the mobile terminal 300 according to an example embodiment of the present invention may comprise a camera part 310, an image analyzing part 320, a verification information receiving part 330, and verification result generating part 340.

The camera part 310 may obtain an image of the web site which the access terminal 100 accesses. That is, the user of the mobile terminal 300 may obtain the image of the web site which the access terminal 100 accesses by using the camera (the camera part 310) installed in the mobile terminal 300.

The image analyzing part 320 may extract web site information including URL information or HTTPS channel configuration information by analyzing the image of the web site which the access terminal 100 accesses. Here, an image processing part may obtain the image of the web site which the access terminal 100 accesses and process the image. That is, the image processing part may include the camera part 310 and the image analyzing part 320.

The verification information receiving part 330 may receive, from the web server 200, verification information for determining whether the web site which the access terminal 100 accesses is normal or falsified based on the URL of the web site. For example, the verification information receiving part 330 may receive, from the web server 200, the verification information including at least one of URL information, session ID information, HTTPS channel configuration information, and information on a web browser of the access terminal 100.

The verification result generating part 340 may generate verification result information on the web site which the access terminal 100 accesses based on the image of the web site and the verification information, and transmit the generated verification result information to the web server 200. That is, the verification result generating part 340 may generate the verification result information by comparing the web site information extracted from the image of the web site and the verification information.

For convenience of explanation, in the above descriptions, each component of the web server 200 and the mobile terminal 300 is explained as an independent entity performing each function. However, at least two of the components may be merged into a single entity, or a single component may be divided into a plurality of entities. Example embodiments having such the merged entity or divided entities are included in the technical scope of the present invention unless they are beyond the technical thought of the present invention.

Also, the methods using the above-described web server 200 and mobile terminal 300 may be implemented as a program or codes in a medium which can be read out by a computer. The computer-readable medium may include all kinds of storage devices which store data which can be read out by a computer system. Also, a program or codes, which can be read out and executed by distributed computer systems connected through networks, may be stored in the computer readable medium.

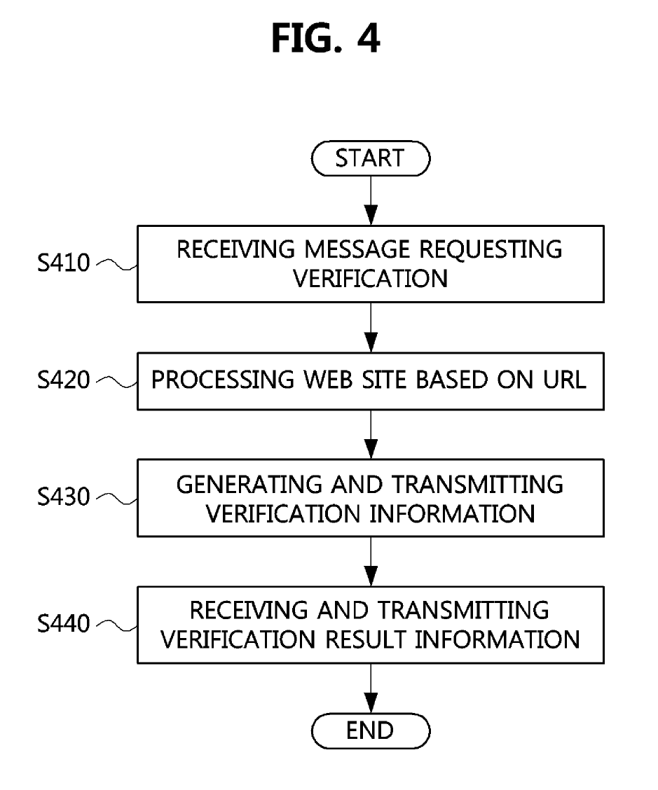

FIG. 4 is a flow chart explaining a method for verifying a web site performed in a web server according to an example embodiment of the present invention.

Referring to FIG. 4, the method for verifying a web site, which is performed in the web server 200 according to an example embodiment of the present invention, may comprise a step S410 of receiving a message requesting verification, a step S420 of processing a web site which the access terminal 100 accesses, a step S430 of generating verification information and transmitting the verification information to a mobile terminal 300, and a step

S440 of transmitting verification result information to the access terminal 100.

The web server may receive a message requesting verification on truth or falsehood of the web site which the access terminal 100 accesses from the access terminal 100 (S410). That is, verification on the web site may be started when the web server 200 receives the message requesting verification from the access terminal 100. Here, the message requesting verification may include information on the target web site, information on a web browser of the access terminal 100, identification information of a user using the access terminal 100, etc.

According to the message requesting verification, the web server 200 may process the web site which the access terminal 100 accesses based on the URL of the web site (S420). For example, the web server 200 may change the URL of the web site into a form of HTTPS, or add information of the user of the access terminal 100 in the web site based on the URL of the web site which the access terminal 100 accesses.

The web server 200 may generate verification information for determining whether the web site which the access terminal 100 accesses is normal or falsified based on the URL of the web site, and transmit the generated verification information to the mobile terminal 300 (S430). Here, the verification information may include URL information, session ID information, HTTPS channel configuration information, and information on a web browser of the access terminal 100.

The web server 200 may receive, from the mobile terminal 300, verification result information on the web site generated in the mobile terminal 300 based on the image of the web site and the verification information, and transmit the received verification result information to the access terminal 100 (S440). Specifically, the mobile terminal 300 may extract web site information including URL information or HTTPS channel configuration information by analyzing the image of the web site, generate the verification result information by comparing the web site information and the verification information, and transmit the generated verification result information to the access terminal 100.

According to the above-described method for verifying a web site, it can be checked whether a web site which an access terminal accesses is a normal site or a falsified site (that is, a phishing site) by using a mobile terminal Therefore, a phishing site can be efficiently blocked without additional hardware or software installed.

Also, since it can be checked whether the target web site is normal or falsified by using the mobile terminal, there can be an advantage of enhancing mobility.

While the example embodiments of the present invention and their advantages have been described in detail, it should be understood that various changes, substitutions and alterations may be made herein without departing from the scope of the invention.

What is claimed is:

1. A web server comprising:
a link information processing part processing a web site which an access terminal accesses based on a Uniform Resource Location (URL) of the web site;
a verification information generating part generating verification information for determining truth or falsehood of the web site based on the URL of the web site and transmitting the generated verification information to a mobile terminal; and
a result information transmitting part receiving verification result information on the web site generated in the mobile terminal based on an image of the web site and the verification information, and transmitting the verification result information to the access terminal.

2. The web server of claim 1, wherein the link information processing part changes the URL of the web site into a form of Hypertext Transfer Protocol over Secure socket layer (HTTPS).

3. The web server of claim 1, wherein the link information processing part adds identification information of a user of the access terminal to the web site which the access terminal accesses based on the URL of the web site.

4. The web server of claim 1, wherein the verification information includes at least one of URL information, session ID information, HTTPS channel configuration information, and information on a web browser of the access terminal.

5. The web server of claim 1, wherein the verification information generating part transmits the verification information to the mobile terminal in order for the mobile terminal to obtain an image of the web site processed by the link information generating part and compare the image and the verification information.

6. A mobile terminal comprising:
a verification information receiving part receiving, from a web server, verification information for judging truth of falsehood of a web site which an access terminal accesses based on a Uniform Resource Location (URL) of the web site;
an image processing part obtaining an image of the web site and processing the image; and
a verification result information generating part generating verification result information on the web site based on the image and the verification information, and transmitting the verification result information to the web server.

7. The mobile terminal of claim 6, wherein the verification information includes at least one of URL information, session ID information, HTTPS channel configuration information, and information on a web browser of the access terminal.

8. The mobile terminal of claim 6, wherein the image processing part comprises:
a camera part obtaining the image of the web site; and
an image analyzing part extracting web site information including URL information or HTTPS channel configuration information by analyzing the image of the web site.

9. The mobile terminal of claim 6, wherein the verification result information part generates the verification result information by comparing the web site information extracted from the image of the web site with the verification information.

10. A method performed in a server verifying a web site, the method comprising:
receiving a message requesting verification on truth or falsehood of a web site which an access terminal accesses from the access terminal;
processing the web site based on a Uniform Resource Location (URL) of the web site according to the message;
generating verification information for verifying truth of falsehood of the web site based on the URL of the web site, and transmitting the verification information to a mobile terminal; and
receiving verification result information on the web site which is generated in the mobile terminal based on an image of the web site and the verification information, and transmitting the verification result information to the access terminal.

11. The method of claim 10, wherein the URL of the web site is changed into a form of Hypertext Transfer Protocol over Secure socket layer (HTTPS) in the processing the web site.

12. The method of claim 10, wherein identification information of a user of the access terminal is added to the web site which the access terminal accesses based on the URL of the web site in the processing the web site.

13. The method of claim 10, wherein the verification information includes at least one of URL information, session ID information, HTTPS channel configuration information, and information on a web browser of the access terminal.

14. The method of claim 10, wherein, in the generating verification information and transmitting the verification information, the verification information is transmitted to the mobile terminal in order for the mobile terminal to obtain an image of the web site and compare the image and the verification information.

15. The method of claim 10, wherein, in the receiving verification result information and transmitting the receiving verification result information, web site information including URL information or HTTPS channel configuration information is extracted by the mobile terminal based on analysis on the image of the web site, the verification result information is generated by comparing the web site information and the verification information and transmitted to the access terminal.
